(19) United States
(12) Patent Application Publication
(10) Pub. No.: US 2004/0060609 A1
(43) Pub. Date: Apr. 1, 2004

(54) Monolayer foamed corrugated sleeve

(76) Inventors: Francis B. Fatato, Exton, PA (US); Eric K. Staudt, Jeffersonville, PA (US)

Correspondence Address: SYNNESTVEDT & LECHNER, LLP, 2600 ARAMARK TOWER, 1101 MARKET STREET, PHILADELPHIA, PA, 191072950

(21) Appl. No.: 10/449,923

(22) Filed: Jun. 2, 2003

Related U.S. Application Data
(60) Provisional application No. 60/385,093, filed on May 31, 2002.

(51) Int. Cl. F16L 11/00

(52) U.S. Cl. 138/121; 264/45.6; 138/156; 425/577

(57) ABSTRACT

A monolayer foamed corrugated sleeve for protecting elongate substrates is disclosed. The sleeve is extruded from a polymer and a foaming agent. The polymer may be a non-elastomeric thermoplastic, a thermoplastic elastomer or a combination of the two. The sleeve is extruded from a nozzle having a cross sectional area which decreases along its length to maintain pressure on the extrudate and prevent premature foaming. The extrudate is released from the nozzle into moving mold blocks. A blow rod within the mold blocks provides gas pressure to force the extrudate against the blocks. An obturation device is mounted on the blow rod to control the gas pressure.

### RELATED APPLICATION

This application is based on and claims the benefit of U.S. Provisional Application No. 60/385,093, filed May 31, 2002.

### FIELD OF THE INVENTION

The invention concerns corrugated foamed sleeving for providing abrasion and thermal protection, as well as acoustic damping for elongated substrates.

### BACKGROUND OF THE INVENTION

Elongated substrates such as wire harnesses, optical fibers and fluid conduits carrying, for example, fuel, compressed gases or hydraulic fluid, are often subjected to harsh environments including vibration, high temperatures and abrasion. For example, wiring passing through an engine compartment of an automobile will be subjected to engine vibration over sustained periods, causing abrasion of the wiring as it rubs against the chassis or body of the automobile. This can lead to short circuits or failure of the wiring. Furthermore, wiring located within the passenger compartment, for example, under the dashboard or within the doors, will also be subject to vibration from engine operation, as well as road noise transmitted through the tires and suspension system. Such wiring will respond with sympathetic vibrations and become a source of rattle noise, annoying to driver and passengers. Fuel or hydraulic lines passing through the engine compartment may be subjected to relatively high temperature, as well as vibration and abrasion. Unless such lines are insulated and the vibration damped, the lines may be subjected to vapor lock, fatigue failure or accelerated corrosion and leakage due to abrasion.

Protection of elongated substrates from multiple environmental factors such as vibration, heat and abrasion usually requires a protective sleeve having multiple components combined together, each component being necessary to address a particular environmental threat to the substrate. For example, the protective sleeve may be formed from a relatively flexible but abrasion resistant plastic shell having a heat reflective coating or layer, as well as a textile layer to provide acoustical damping. Such a construction, while perhaps effectively protecting the substrate from the various adverse environments, is relatively expensive to produce because multiple layers of differing materials must be formed and joined in such a way as to hold together under the stress of the environments yet function separately and effectively to provide protection from each different threat to the integrity of the substrate. Clearly, there is an advantage to providing a protective sleeve comprising a single layer having the capability to protect elongated substrates from multiple harsh environments.

### SUMMARY AND OBJECTS OF THE INVENTION

The invention concerns a sleeve for providing abrasion protection, thermal protection and acoustic damping to elongated substrates such as wiring harnesses, optical fibers and fluid carrying conduits. The sleeve comprises a corrugated foam tube surrounding a central space for receiving the elongated items. The foam tube is extruded from a mixture of materials in liquid form including a polymer and a foaming agent. The polymer constituent may include a non-elastomeric thermoplastic, a thermoplastic elastomer or a combination of the two. The tube is also provided with circumferentially extending corrugations, the corrugations being molded in while the mixture is in the process of solidifying.

Various polymers such as polyethylene, polypropylene, polystyrene, nylon, polyester, acrylonitrile butadiene styrene, ethyl vinyl acetate and polyvinyl chloride are feasible for the non-elastomeric thermoplastic component. Copolymers of polypropylene and ethylene propylene diene monomer, thermoplastic vulcanizates, thermoplastic polyurethane and thermoplastic olefin may be used as the thermoplastic elastomer. The foaming agent preferably comprises an endothermic substance which releases carbon dioxide gas upon heating.

Furthermore, exothermic substances may also be used as well as mixtures of endothermic and exothermic substances. Heating these substances produces gas to foam the extrudate.

The non-elastomeric thermoplastic component may comprise between about 20 wt % and about 96 wt % of the tube, the thermoplastic elastomer component may comprise between about 3 wt % and about 80 wt % of the tube, and the foaming agent may comprise between about ½ wt % to about 10 wt % of the tube.

Preferably, the tube has a lengthwise oriented slit to provide access to the central space for positioning the elongated substrates within the central space.

One method of producing a corrugated foam tube as described above may comprise the following steps:

(A) providing a liquid mixture of a polymer and a foaming agent;

(B) reacting the foaming agent to release a gas into solution in the liquid mixture;

(C) extruding the liquid mixture under pressure through a die to form a tubular sidewall;

(D) maintaining the pressure on the liquid mixture during the extruding step so that the gas remains in solution while the polymer solidifies;

(E) molding corrugations into the sidewall of the partially solidified mixture;

(F) allowing the gas to come out of solution to form bubbles in the partially solidified mixture thereby creating gas filled voids in the sidewall; and

(F) causing the partially solidified mixture to solidify into the corrugated sleeve.

The invention also contemplates a die attachable to an extruder for forming the monolayer foamed corrugated sleeve from an extrudate. The die comprises an elongated nozzle attachable to the extruder. The nozzle has a tapered bore in fluid communication with the extruder for receiving the extrudate under pressure. The tapered bore maintains pressure on the extrudate as the extrudate passes through the nozzle. An elongated pin is positioned coaxially within the nozzle. The nozzle and the pin are sized to define an annular conduit of decreasing cross-sectional area within the nozzle. The annular conduit shapes the extrudate into a tubular extrusion as the extrudate passes through the nozzle. The nozzle cooperates with means known in the art for molding corrugations in the tubular extrusion upon emergence of the tubular extrusion from the nozzle.

The invention also includes an obturation device positionable on a blow rod within mold cavities of a plurality of movable mold blocks for the molding of continuous tubular sleeving. The blow rod has a bore through which compressed gas may flow and an aperture providing fluid communication between the bore and the mold cavities. The obturation device comprises a blocking body mountable on the blow rod downstream from the aperture. The blocking body is sized to substantially fill the mold cavities and substantially block said compressed gas entering the cavities through the aperture. The blocking body has a passageway extending lengthwise therethrough for venting the compressed gas within the mold cavities past the blocking body.

The obturation device may also include a shielding body positionable on the blow rod between the aperture and the blocking body. The shielding body is sized smaller than the blocking body, the shielding body shielding the passageway within the blocking body from contamination.

It is an object of the invention to provide a monolayer foamed corrugated sleeve for protecting elongated substrates.

It is another object of the invention to provide a corrugated sleeve formed of a polymer and a foaming agent.

It is still another object of the invention to provide a sleeve wherein the polymer includes a non-elastomeric thermoplastic.

It is again another object of the invention to provide a sleeve wherein the polymer includes a thermoplastic elastomer.

It is yet another object of the invention to provide a method of making a monolayer foamed corrugated sleeve.

It is a further object of the invention to provide a nozzle for extruding a monolayer foamed corrugated sleeve.

It is again a further object of the invention to provide an obturation device for molding a monolayer foamed corrugated sleeve.

These and other objects and advantages of the invention will become apparent upon consideration of the drawings and the detailed description of the preferred embodiments of the invention.

### BRIEF DESCRIPTION OF THE DRAWINGS

FIG. 1 is a side view of a monolayer foamed corrugated sleeve according to the invention;

FIG. 2 is a partial sectional view of a portion of the sleeve shown in FIG. 1 on an enlarged scale;

FIG. 3 is a flow chart illustrating a process for producing a monolayer foamed corrugated sleeve according to the invention;

FIG. 4 is a side view of a machine for continuously extruding and molding monolayer foamed corrugated sleeve according to the invention;

FIG. 4A is a partial sectional view on an enlarged scale of the portion of FIG. 4 within circle 4A;

FIG. 5 is a sectional view of the machine shown in FIG. 4 on an enlarged scale;

FIG. 5A is a sectional view on an enlarged scale of the portion of FIG. 5 within circle 5A;

FIG. 6 is a cross-sectional view taken at line 6-6 of FIG. 5;

FIG. 7 is a cross-sectional view taken at line 7-7 of FIG. 5;

FIG. 8 is a cross-sectional view taken at line 8-8 of FIG. 5A; and

FIG. 9 is a side view of an alternate embodiment of a blocking body according to the invention.

### DETAILED DESCRIPTION OF THE PREFERRED EMBODIMENTS

FIG. 1 shows a monolayer foamed corrugated sleeve 10 according to the invention. Sleeve 10 comprises a tube 12 having a sidewall 14 with corrugations 16 formed from a plurality of crests 18 and troughs 20 arranged one adjacent the other in alternating fashion. Corrugations 16 are preferably circumferentially oriented around tube 12 and provide radial stiffness to the tube to prevent collapse while also allowing for bending flexibility so that the sleeve 10 can be bent without kinking to follow the path of the substrates it is intended to protect. The sidewall 14 is a monolayer and surrounds a central space 22 for receiving the elongated substrates 23, for example, a wiring harness. The sidewall 14 may be a circumferentially continuous structure or it may have a slit 24 arranged lengthwise along the tube 12. Slit 24 penetrates the sidewall 14 substantially along the length of the tube and provides access to the central space 22, allowing the tube to receive substrates whose ends are inaccessible. The tube is resiliently biased so that slit 24 normally remains closed, but the sidewall 14 is also flexible allowing the slit 24 to be manually opened for access to the central space 22.

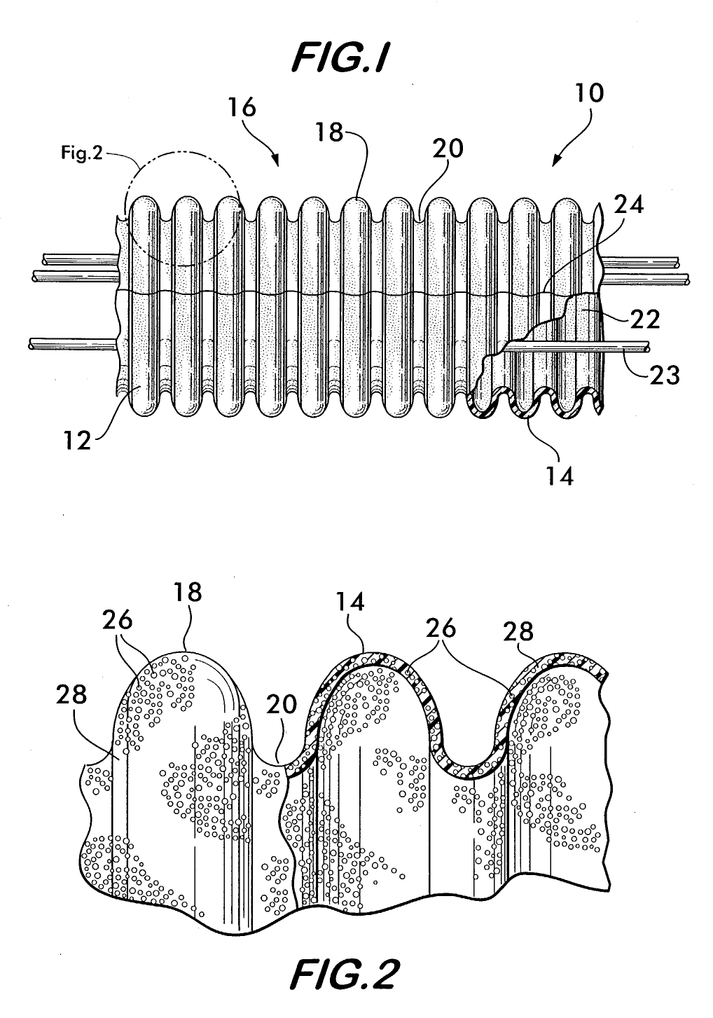

FIG. 2 shows a portion of tube 12 comprising a crest 18 and a trough 20 on an enlarged scale to illustrate the foamed construction of the sleeve 10. The foamed construction features gas-filled cellular voids 26 distributed throughout a matrix 28 comprised of various polymers and foaming agents described in detail below. The monolayer foamed construction of the tube 12 permits the sleeve 10 to provide protection to the substrates within the central space 22 from multiple different environmental threats with a single layer tube. The polymer matrix 28 affords abrasion protection, as well as protection against shock and impact forces. The well distributed cellular voids 26 provide excellent thermal protection since heat transfer across the sidewall 14 of the tube 12 is effectively inhibited by the presence of the gas-filled cellular voids throughout the matrix, which disrupt conductive heat transfer. The voids 26 also absorb sound and other vibration energy thereby providing acoustic and vibrational damping protection to the substrates. Such protection is important to avoid fatigue failure of metal substrates subjected to sustained vibrational environments such as found in automobiles and aircraft. To take best advantage of the foamed construction of the tube, it is preferred that the thickness of sidewall 14 be between about ½ mm and about 3 mm.

The polymer matrix 28 comprising tube 12 is formed from a mixture of one or more polymers and a foaming agent. The polymer component of the mixture may be a non-elastomeric thermoplastic, a combination of non-elastomeric thermoplastics, a thermoplastic elastomer, a combination of thermoplastic elastomers or a combination of non-elastomeric thermoplastics and thermoplastic elastomers. The ratio of the constituents is varied to achieve desired material properties in the sleeve 10. For example, to provide a softer tube having increased flexibility and acoustic damping properties, the ratio of thermoplastic elastomer is increased relative to the non-elastomeric thermoplastic constituent. To construct a harder, stiffer tube with improved abrasion resistance the ratio of non-elastomeric thermoplastic is increased relative to the thermoplastic elastomer. To increase the thermal insulating capacity or decrease the density of the tube, the amount of foaming agent is increased. (Damping and thermal insulation characteristics of the sleeve may also be affected by increasing or decreasing sidewall thickness.)

The non-elastomeric thermoplastic constituent may be chosen from polymers such as polyethylene, polypropylene, polystyrene, nylon, polyester, ethyl vinyl acetate, acrylonitrile butadiene styrene and polyvinyl chloride plastics. The thermoplastic elastomer may be copolymers of polypropylene and natural and synthetic rubber compounds such as thermoplastic vulcanizates, ethylene propylene diene monomer or thermoplastic polyurethanes and thermoplastic olefins. The foaming agents may be endothermic or exothermic agents. Endothermic foaming agents are compounds which release a gas, such as carbon dioxide upon heating. Commercially available foaming agents are sold under the trademark Clariant Masterbatches Hydrocerol BIH-40E and are also available from Reedy International.

The various constituents can be combined in a range of ratios. In formulations wherein the polymer component comprises only a non-elastomeric thermoplastic, the non-elastomeric thermoplastic component may be between about 50 wt % and about 96 wt % of the mixture with the foaming agent accounting for between about ½ wt % and about 10 wt %. Where only a thermoplastic elastomer is present as the polymer component, the thermoplastic elastomer may be between about 50 wt % and about 96 wt %, with the foaming agent being between about ½ wt % and about 10 wt %. In formulations comprising both a non-elastomeric thermoplastic and a thermoplastic elastomer component, the non-elastomeric thermoplastic component is between about 20 wt % and about 96 wt % of the mixture, the thermoplastic elastomer is between about 3 wt % and about 80 wt % of the mixture, and the foaming agent is between about ½ wt % and about 10 wt % of the mixture.

The following examples illustrate practical monolayer foamed sleeves according to the invention.

### EXAMPLE 1

A monolayer foamed sleeve was produced from a combination of low density polyethylene (87.8 wt %), a copolymer of polypropylene and ethylene propylene diene monomer (9.8 wt %) sold under the trademark “Santoprene” (Advanced Elastomer Systems 121-68W228) and a foaming agent (2.4 wt %) comprising Clariant Masterbatches Hydrocerol BIH-40E. A polypropylene may be substituted for the low density polyethylene to increase both the abrasion resistance and the maximum exposure temperature of the sleeve.

### EXAMPLE 2

A monolayer foamed sleeve was produced having 91 wt % ethyl vinyl acetate, 4 wt % foaming agent and 5 wt % colorant. The ethyl vinyl acetate is a thermoplastic polyethylene with 28 wt % vinyl acetate as an additive. Sleeves having this formulation exhibit very good acoustic attenuation and are soft and flexible to the touch. Higher percentages of vinyl acetate additive increase the softness and the acoustic attenuation.

### EXAMPLE 3

A monolayer foamed sleeve was produced comprising 66.5 wt % thermoplastic vulcanizate available under the commercial name “Sarlink”, 28.5 wt % polyethylene, and 5 wt % foaming agent. The resultant sleeve is soft and flexible with excellent acoustic attenuation characteristics. Because of the relatively high percentage of thermoplastic vulcanizate, the sleeve has lower abrasion resistance than sleeves made from formulations having a greater percentage of polyethylene.

### EXAMPLE 4

A monolayer foamed sleeve was produced comprising 47.5 thermoplastic vulcanizate, 47.5 wt % polyethylene and 5 wt % foaming agent. Sleeves made according to this formulation are harder than versions having more thermoplastic vulcanizate but still maintained good acoustic attenuation properties. The abrasion resistance provided by this formulation is markedly higher than formulations having a higher percentage of thermoplastic vulcanizate.

### EXAMPLE 5

A monolayer foamed sleeve was produced comprising 9.2 wt % thermoplastic vulcanizate, 82.8 wt % polyethylene, 4 wt % foaming agent and 4 wt % colorant. Sleeves made from this formulation are harder than the sleeve described in Example 4, yet maintain good acoustic attenuation properties. Abrasion resistance increased by 25% over Example 4.

### EXAMPLE 6

A monolayer foamed sleeve was produced comprising 66.5 wt % thermoplastic vulcanizate, 28.5 wt % polypropylene and 5 wt % foaming agent. This formulation produced a sleeve having an increased abrasion resistance of 1000% over a similar formulation substituting polyethylene for the polypropylene. The higher abrasion resistance was accompanied by higher sleeve stiffness.

### EXAMPLE 7

A monolayer foamed sleeve was produced comprising 27.6 wt % thermoplastic olefin (sold under the commercial name “Newcon” by Chisso, Inc.), 64.4 wt % polypropylene, 4 wt % foaming agent and 4 wt % colorant. The abrasion resistance of this formulation is 10 times greater than Example 6. The sleeve is hard to the touch but has a relatively low density and a higher melting temperature than similar formulations using polyethylene.

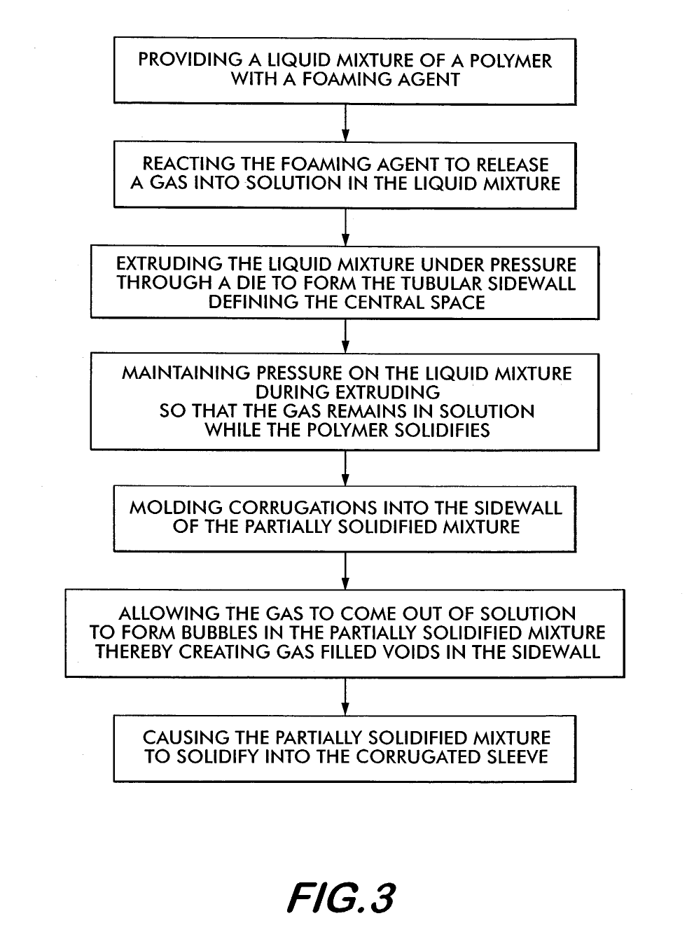

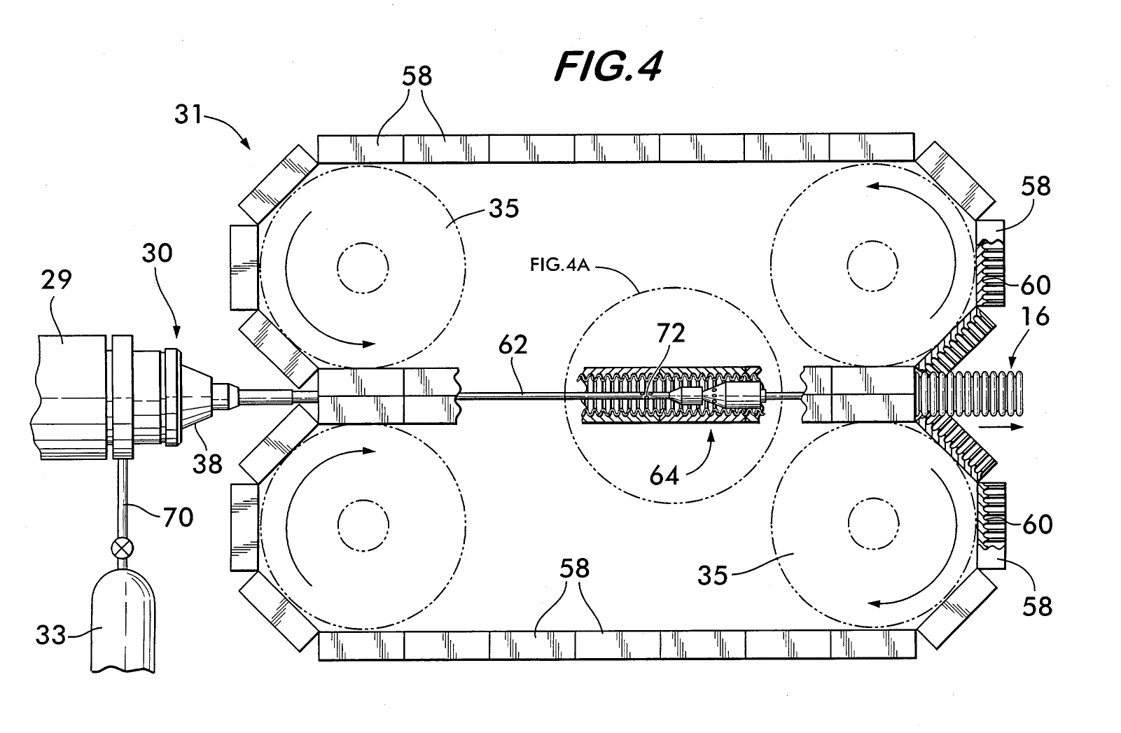

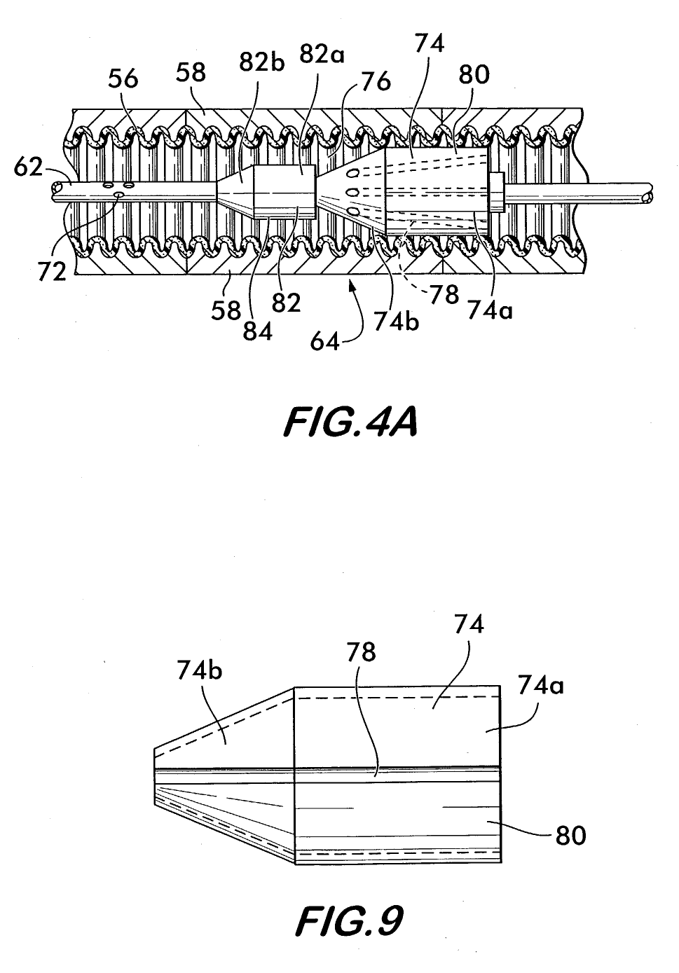

In the process of making the monolayer foamed corrugated sleeve described in FIG. 3, the polymer component or components and the foaming agent are preferably received in pelletized solid form and mixed together in the desired proportions. The mixture of pelletized constituents is provided to an extruder 29, shown in FIG. 4, which heats and masticates the mixture into a molten extrudate. Due to the heat, the foaming agent releases its gas, but the extrudate is maintained within the extruder under high pressure which keeps the gas in solution within the mixture and prevents premature foaming of the gas. Premature foaming leads to non-homogeneously distributed voids forming in the matrix which cannot result in a true foam being formed. The molten extrudate is passed through a tube forming die 30 (described in detail below) which forms the extrudate into a tube having a sidewall surrounding a central space and defining the sleeve. As the die formed tube emerges from the die 30, the extrudate is no longer under pressure and the gas from the foaming agent comes out of solution and forms the foam. To corrugate the tube sidewall, it is fed while it begins to solidify into a corrugating machine 31 having a plurality of mold blocks 58. Each mold block comprises two half molds which are brought together around the tube. Compressed gas, preferably air, from a compressed gas source 33 is injected into the tube's central space to force its outer surface into contact with the inner surface 60 of the mold blocks 58 and the tube takes on the corrugated shape present on the inner surface 60 of the mold block. The mold blocks 58 are applied continuously one behind another onto the tube as it emerges from the die 30. The mold blocks are transported away from the die on an endless conveyor system 35 (shown schematically), thus allowing for continuous production of virtually infinite length monolayer foamed corrugated sleeving 10. The mold blocks 58 may be cooled to help solidify the extrudate into its final shape. Upon sufficient solidifying of the sleeve, the mold blocks are removed and cycled back by the conveyor system 35 in the continuous process. The polymer constituents chosen form a resilient, flexible monolayer foamed corrugated sleeve 10 which can readily accommodate elongated substrates and conform to whatever path is required to follow the substrate. The tube 10 may be slit after cooling and solidifying and may be resiliently biased so that the slit is normally closed, overlapping or open as desired for a particular application.

While it is preferred to produce a molten extrudate by heating the polymer-foaming agent mixture using the heat to react, the foaming agent to release its gas and then to solidify the foamed extrudate by cooling it while molding, it is also contemplated that a liquid mixture of polymer constituents and foaming agent not requiring heating could also be provided, that the foaming agent may be reacted by means other than heating (by chemical means, for example) and that the liquid mixture may solidify or cure without the need for cooling, for example, by chemical means, depending upon the specific constituents comprising the mixture.

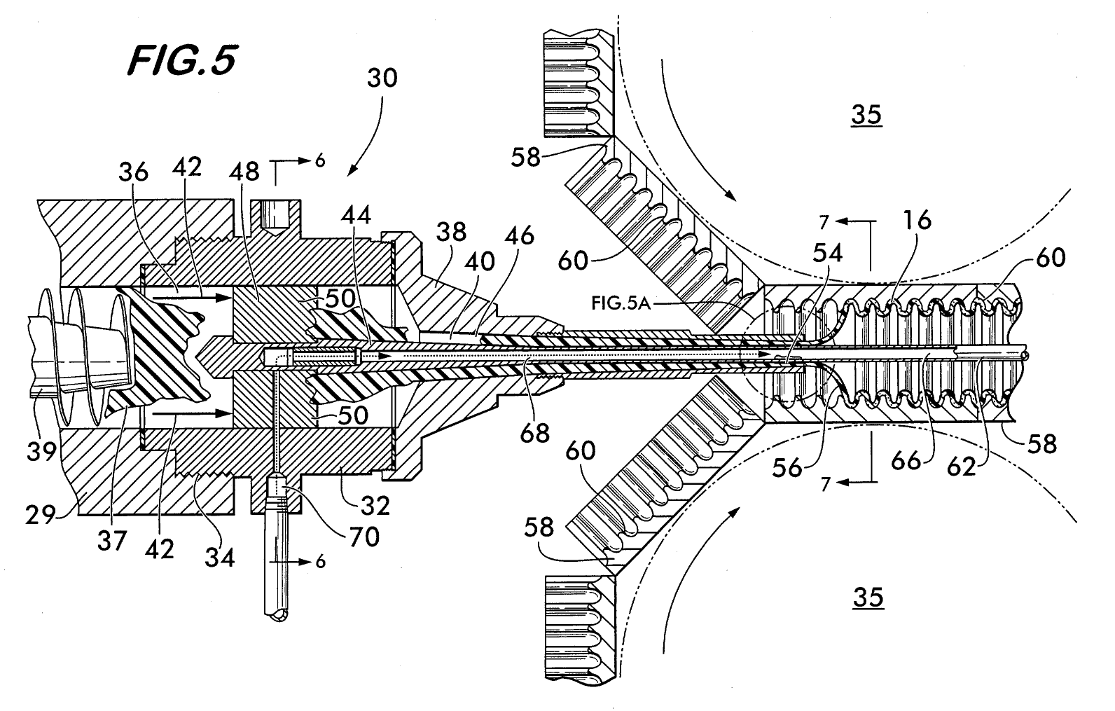

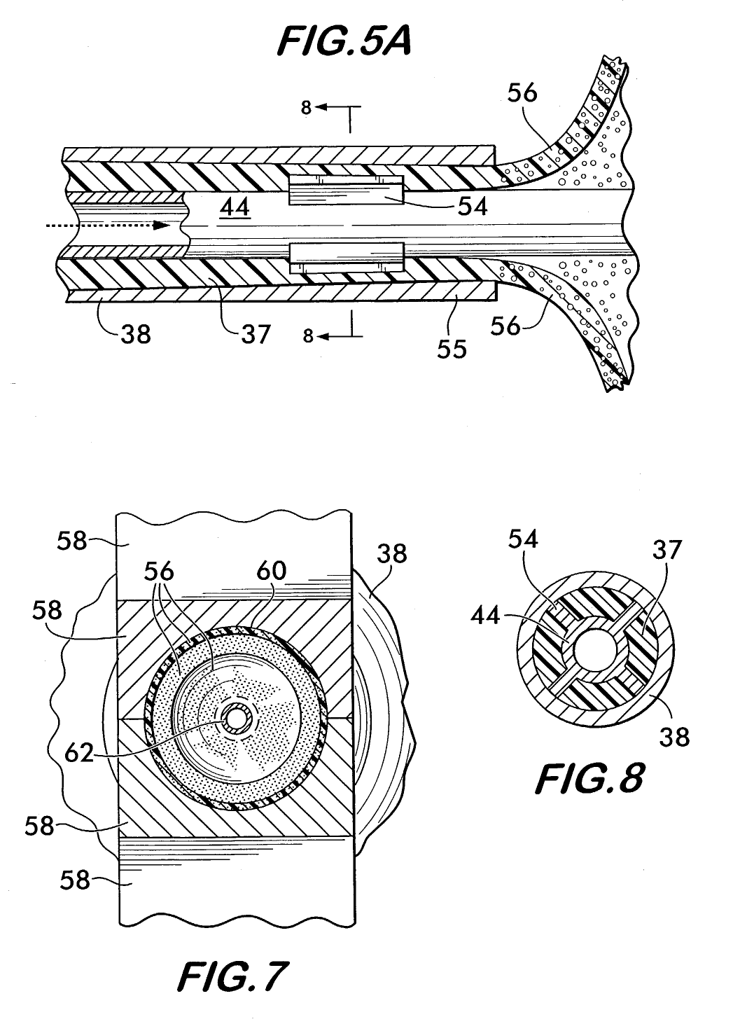

FIG. 5 shows, in detail, a portion of the extruder 29 and the die 30 for extruding the monolayer foamed corrugated sleeve 10. As described above, molten extrudate 37 is advanced under pressure, preferably by a screw feed 39, into the die 30. Die 30 comprises a housing 32 for mounting the die to the extruder 29 by means of screw threads 34, for example, thus allowing for interchangeability of the die. Housing 32 defines a chamber 36 in fluid communication with the extruder 29 to receive extrudate 37 under pressure. An elongated nozzle 38 is attached to the housing 32. Nozzle 38 has an elongated tapered bore 40 which is in fluid communication with the extruder via the housing 32. Bore 40 receives extrudate from the chamber 36 and is tapered lengthwise so as to become smaller in the downstream direction of the extrudate indicated by arrows 42. By tapering the bore 40, the extrudate 37 is maintained under pressure to prevent premature foaming within the die 30. Premature foaming is to be avoided as it results in irregularly distributed voids being formed in the matrix comprising the sidewall of the sleeve. Such a construction is not a true foam and will not have the desired damping, density and insulating characteristics of the monolayer foamed corrugated sleeve according to the invention.

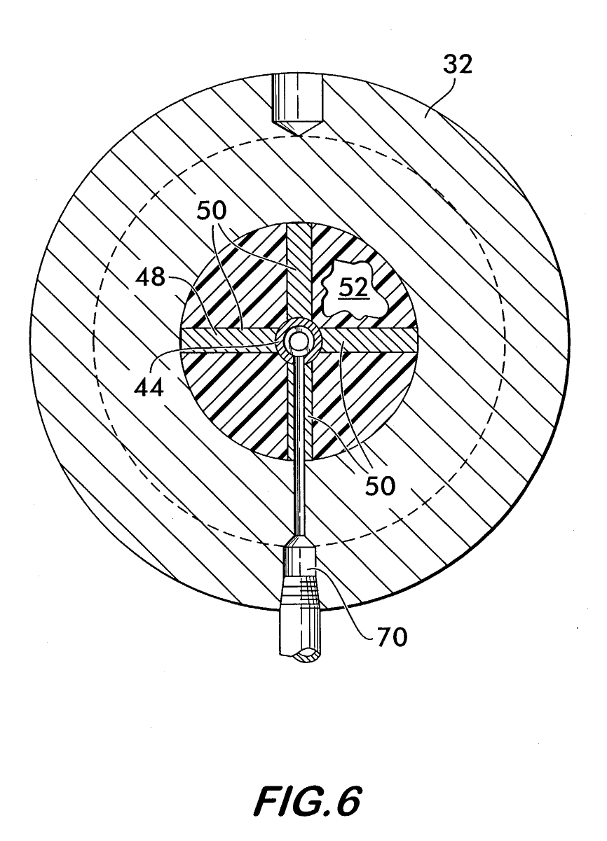

An elongated pin 44 is positioned coaxially within the bore 40 of nozzle 38. The pin is preferably tapered lengthwise and sized to fit within the bore 40 and define an annular conduit 46 of decreasing cross-sectional area within the nozzle 38. The pin 44 and tapered bore 40 cooperate to maintain the pressure on the extrudate 37 as it traverses the nozzle 38 to avoid the premature foaming. As best shown in FIG. 6, pin 44 is supported at an upstream end by a support spider 48 having a plurality of legs 50 which extend radially outwardly to engage the housing 32. Spaces 52 between the legs 50 allow the extrudate to pass through the housing and into the bore 40. As shown in FIGS. 5A and 8, a similar support spider 54 is provided at the downstream end of the nozzle 38. Both spiders support the pin 44 and help it maintain a centered position coaxially within the nozzle 38.

During manufacture of the monolayer foamed corrugated sleeve as illustrated in FIG. 5, extrudate 37 is forced from the extruder 29 under pressure into chamber 36 of housing 32. The extrudate continues on hydraulically into the annular conduit 46 within nozzle 38 where the pin 44 and the bore 40 cooperate to shape the extrudate into a tubular extrusion 56. The support spiders 48 and 54 work together to keep the pin 44 centered within the bore 40 of the nozzle 38 to ensure that the tubular extrusion has a uniform wall thickness. If the pin were to shift, the sidewall of the extrusion would be thinner on the side to which the pin shifted.

As shown in FIG. 5A, the extrudate 37 forming the tubular extrusion must separate to pass the legs of the downstream support spider 54. After passing the spider, the extrudate then normally rejoins to form a continuous tubular extrusion, and no seam marking this rejoining is discernable along the sleeve in its final state. However, for extrudate which does not readily rejoin after passing the spider the nozzle may include a rejoining section 55 which extends beyond the spider 54 to provide a region over which the extrudate is still substantially under hydraulic compression to facilitate rejoining. It is thought that mixing of the extrudate is enhanced by the foaming action as it leaves the die, thereby promoting seamless rejoining of the extrudate as the tubular extrusion is formed.

As noted, foaming action of the extrudate occurs as the tubular extrusion 56 exits the nozzle 38. As shown in FIGS. 5 and 7, upon exiting the nozzle, the tubular extrusion 56 is received by mold blocks 58 which surround the extrusion and form the corrugations of the sleeve. As described above, the blocks 58 are split into halves and brought together by the endless conveyor 35 around the tubular extrusion 56 as it exits the nozzle 38. The inner surfaces 60 of the blocks 58 are shaped to mold the tubular extrusion into the crests and troughs of the corrugations.

To ensure that the extrudate 37 conforms to the shape of the inner surface 60 of mold blocks 58, a region of increased gas pressure is maintained within the central space 22 defined within the tubular extrusion 56. As shown in FIG. 4, the increased gas pressure is effected through the use of a blow rod 62 on which is mounted an obturation device 64. The blow rod extends from nozzle 38 coaxially within the tubular extrusion 56 and the obturation device 64 is positioned downstream from nozzle 38 at a considerable distance, for example, on the order of 48 inches away.

As shown in FIG. 5, blow rod 62 has a bore 66 in fluid communication with a bore 68 through pin 44. Both the pin bore 68 and the blow rod bore 66 receive compressed gas from the gas reservoir 33 (see FIG. 4) through a duct 70 which is connected to the pin bore 68 through one of the legs 50 of spider 48 (see FIG. 5). As shown in FIG. 4, the gas exits the blow rod 62 through one or more apertures 72 positioned just upstream of the obturation device 64. Preferably, the apertures 72 are positioned at equally spaced intervals circumferentially around the blow rod 62 to ensure equal gas pressure on the extrudate.

As shown in FIG. 4A, the obturation device 64 comprises a blocking body 74 mounted on the blow rod 62. Blocking body 74 is preferably an elongated segment 74a having a tapered end 74b positioned facing upstream toward apertures 72. The blocking body 74 is sized so as to substantially fill the mold cavity 76 defined by mold blocks 58 so as to substantially block the gas entering the tubular extrusion 56 through apertures 72 and thereby create the region of increased gas pressure extending from the obturation device 64 upstream to the nozzle 38. The blocking body 74 has one or more lengthwise extending passageways 78 for venting the gas from the region of increased pressure past the blocking body 74 to the ambient. Multiple passageways 78 positioned at equally spaced intervals around the blocking body 74 are preferred to provide a symmetric flow of gas past the body and thereby not adversely affect the symmetry of the tubular extrusion 56. The passageways 78 may be positioned within the blocking body 74 or may be channels extending along the surface of the body as shown in FIG. 9. The passageways 78 are sized so as to vent the gas at a rate which will maintain the region of increased pressure but not allow the pressure therein to become excessive and cause a blow-out of the extrudate 37 from the mold block 58. A blow out may occur if the gas pressure within the mold cavity increases to the point that the extrudate is forced out between the seam of two mold block halves or the juncture between two adjacent mold blocks or at the point where the nozzle interfaces with the mold blocks.

Because the blocking body 74 is in close proximity to the tubular extrusion 56, extrudate 37 forming the extrusion will tend to accumulate on the body 74, eventually clogging the passageways 78 and precipitating a blow out. It is, therefore, advantageous that at least the outer surface 80 of the blocking body comprise a material having a relatively low coefficient of friction. Materials such as polytetrafluoroethylene are preferred and the blocking body may be coated with the low friction material or be made entirely from it.

Another measure for preventing clogging of the passageways 78 with extrudate 37 is by positioning a shielding body 82 immediately upstream of the blocking body 74. The shielding body 82 is part of the obturation device 64 and is smaller in size than the blocking body 74. The shielding body 82 preferably comprises an elongated segment 82a with a tapered end 82b and is positioned upstream of the blocking body 74 to deflect any extrudate 37 which would otherwise tend to be drawn into the passageways 78. As with the blocking body 74, it is advantageous that the tapered end 82b of the shielding body 82 face upstream toward the apertures 72 and the outer surface 84 of the shielding body 82 comprise a material having a low friction coefficient so as to prevent extrudate build up. Polytetrafluoroethylene is again the preferred material and may be coated onto the shielding body 82 or may comprise the entire body.

Extrudate build up on the blocking body is further avoided by positioning the apertures 72 and the obturation device 64 at a significant distance downstream from the nozzle 38. This gives the extrudate 37 time to cool and harden from the substantially molten state which it is in as it exits the nozzle 38. Cooled, hardened extrudate is less likely to accumulate on either the blocking or shielding bodies 74 and 82 even if there is some contact between the blocking body 74 and the tubular extrusion 56 as the extrusion moves past the body. The positioning described above is also advantageous if chemical means are used to solidify the extrudate, as the position of the obturation device 64, distant from the nozzle 38, gives more time for any chemical reactions to occur to effect solidification.

Monolayer corrugated foamed sleeves according to the invention provide a flexible, resilient foam sleeve which can bend without kinking and provide protection against multiple environmental threats such as abrasion, heat and vibration with a tube having a single layer formed inexpensively and simply from a combination of constituents whose proportions may be varied to achieve specific desired characteristics.

What is claimed is:

1. A sleeve for providing abrasion protection, thermal protection and acoustic damping to elongated substrates, said sleeve comprising:
a tubular sidewall surrounding and defining an elongated central space for receiving the elongated items;
a multiplicity of gas-filled voids dispersed throughout said sidewall; and
alternating crests and troughs molded into said sidewall.

2. A sleeve according to claim 1, wherein said crests and troughs extend circumferentially around said central space.

3. A sleeve according to claim 1, further comprising a lengthwise oriented slit through said sidewall, said slit providing access to said central space for positioning the elongated substrates therewithin.

4. A sleeve according to claim 1, wherein said sidewall has a thickness between about ½ mm and about 3 mm.

5. A sleeve according to claim 1, wherein said sidewall is formed from a mixture of materials including a non-elastomeric thermoplastic and a foaming agent.

6. A sleeve according to claim 5, wherein said non-elastomeric thermoplastic is selected from the group consisting of polyethylene, polypropylene, polystyrene, nylon, polyester, acrylonitrile butadiene styrene, ethyl vinyl acetate and polyvinyl chloride.

7. A sleeve according to claim 5, wherein said non-elastomeric thermoplastic comprises between about 50 wt % and about 96 wt % of said mixture, and said foaming agent comprises between about ½ wt % and about 10 wt % of said mixture.

8. A sleeve according to claim 5, wherein said mixture comprises about 91 wt % ethyl vinyl acetate and about 4 wt % foaming agent.

9. A sleeve according to claim 1, wherein said sidewall is formed from a mixture of materials including a thermoplastic elastomer and a foaming agent.

10. A sleeve according to claim 9, wherein said thermoplastic elastomer is selected from the group consisting of copolymers of polypropylene and ethylene propylene diene monomer, thermoplastic vulcanizates, thermoplastic polyurethanes and thermoplastic olefins.

11. A sleeve according to claim 9, wherein said thermoplastic elastomer comprises between about 50 wt % and about 96 wt % of said mixture, and said foaming agent comprises between about ½ wt % and about 10 wt % of said mixture.

12. A sleeve according to claim 9, wherein said mixture comprises about 66.5 wt % thermoplastic vulcanizate, about 28.5 wt % polypropylene and about 5 wt % foaming agent.

13. A sleeve according to claim 9, wherein said mixture comprises about 27.6 wt % thermoplastic olefin, about 64.4 wt % polypropylene and about 4 wt % foaming agent.

14. A sleeve according to claim 1, wherein said sidewall is formed from a mixture of materials including a non-elastomeric thermoplastic, a thermoplastic elastomer and a foaming agent.

15. A sleeve according to claim 14, wherein said non-elastomeric thermoplastic is selected from the group consisting of polyethylene, polypropylene, polystyrene, nylon, polyester, acrylonitrile butadiene styrene, ethyl vinyl acetate and polyvinyl chloride.

16. A sleeve according to claim 14, wherein said thermoplastic elastomer is selected from the group consisting of copolymers of polypropylene and ethylene propylene diene monomer, thermoplastic vulcanizates, thermoplastic polyurethanes and thermoplastic olefins.

17. A sleeve according to claim 14, wherein said non-elastomeric thermoplastic comprises between about 20 wt % and about 96 wt % of said mixture, said thermoplastic elastomer comprises between about 3 wt % and about 80 wt % of said mixture and said foaming agent comprises between about ½ wt % and about 10 wt % of said mixture.

18. A sleeve according to claim 14, wherein said mixture comprises about 87.8 wt % polyethylene, about 9.8 wt % copolymer of polypropylene and ethylene propylene diene monomer, and about 5 wt % foaming agent.

19. A sleeve according to claim 14, wherein said mixture comprises about 28.5 wt % polyethylene, about 66.5 wt % thermoplastic vulcanizate, and about 5 wt % foaming agent.

20. A sleeve according to claim 14, wherein said mixture comprises about 47.5 wt % polyethylene, about 47.5 wt % thermoplastic vulcanizate and about 5 wt % foaming agent.

21. A sleeve according to claim 14, wherein said mixture comprises about 82.8 wt % polyethylene, about 9.2 wt % thermoplastic vulcanizate and about 4 wt % foaming agent.

22. A method of producing a corrugated sleeve having a tubular sidewall with a multiplicity of gas filled voids therein, said sleeve providing abrasion protection, thermal protection and acoustic damping to elongated substrates positioned within a central space surrounded and defined by said sidewall, said method comprising the steps of:
providing a liquid mixture of a polymer with a foaming agent;
reacting said foaming agent to release a gas into solution in said liquid mixture;
extruding said liquid mixture under pressure through a die to form said tubular sidewall defining said central space;
maintaining the pressure on said liquid mixture during said extruding step so that said gas remains in solution while said polymer commences solidification;
molding corrugations into said sidewall of said partially solidified mixture;
allowing said gas to come out of solution and form bubbles in said partially solidified mixture thereby creating said gas filled voids in said sidewall; and
causing said partially solidified mixture to solidify into said corrugated sleeve.

23. A method according to claim 22, wherein said liquid mixture is a molten mixture.

24. A method according to claim 22, wherein said reacting step comprises heating said mixture.

25. A method according to claim 24, wherein said partially solidified mixture is caused to solidify by cooling said mixture.

26. A method according to claim 22, wherein said polymer includes a non-elastomeric thermoplastic.

27. A method according to claim 22, wherein said polymer includes a thermoplastic elastomer.

28. A method according to claim 26, wherein said polymer includes a thermoplastic elastomer.

29. A method according to claim 22, wherein said step of maintaining the pressure on said liquid mixture is effected by extruding said liquid mixture through a die comprising an elongated, tapered nozzle.

30. A method according to claim 29, wherein said step of molding corrugations into said tube comprises:
extruding said liquid mixture into a mold having a corrugated surface; and
injecting a gas under pressure within said central space, said gas forcing said liquid mixture against said corrugated surface of said mold.

31. A die attachable to an extruder for forming a sleeve from an extrudate containing a foaming agent, said sleeve having a tubular sidewall with a multiplicity of gas filled voids therein, said sidewall surrounding and defining a central space, said die comprising:
an elongated nozzle having a bore and being attachable to said extruder;
an elongated pin positioned coaxially within said bore, said nozzle and said pin being relatively sized to define an annular conduit of decreasing cross sectional area, said annular conduit being positionable in fluid communication with said extruder for receiving said extrudate under pressure therefrom, said annular conduit maintaining pressure on said extrudate while it passes therethrough thereby preventing said foaming agent from forming gas bubbles in said extrudate, said annular conduit shaping said extrudate into said tubular sidewall when said extrudate exits said annular conduit, said foaming agent forming a multiplicity of gas filled voids distributed throughout said sidewall upon said extrudate exiting said conduit.

32. A die according to claim 31, wherein said bore and said pin are tapered lengthwise to form said annular conduit of decreasing cross section.

33. A die according to claim 31, further comprising a bore positioned lengthwise within said pin, said bore being in fluid communication with a compressed gas source and said central space, said compressed gas from said source being flowable through said bore and into said central space for expanding said sidewall radially outwardly.

34. An obturation device positionable on a blow rod within mold cavities of a plurality of movable mold blocks for the molding of continuous tubular sleeving, said blow rod having a bore through which compressed gas may flow and an aperture providing fluid communication between said bore and said mold cavities, said obturation device comprising a blocking body mountable on said blow rod downstream from said aperture, said blocking body being sized to substantially fill said mold cavities and substantially block said compressed gas entering said cavities through said aperture, said blocking body having a passageway extending lengthwise therethrough for venting said compressed gas within said mold cavities past said blocking body.

35. An obturation device according to claim 34, further comprising a plurality of passageways extending lengthwise through said blocking body, said passageways being distributed at equally spaced intervals around said blocking body.

36. An obturation device according to claim 34, wherein said passageway comprises an open channel formed lengthwise along an outer surface of said blocking body.

37. An obturation device according to claim 34, wherein said blocking body comprises an elongated segment coaxially positionable on said blow rod.

38. An obturation device according to claim 37, wherein said blocking body further comprises a tapered end positionable facing said aperture.

39. An obturation device according to claim 34, wherein said blocking body has an outer surface comprising a material having a relatively low coefficient of friction.

40. An obturation device according to claim 39, wherein said material comprises polytetrafluoroethylene.

41. An obturation device according to claim 34, wherein said blocking body comprises a material having a relatively low coefficient of friction.

42. An obturation device according to claim 41, wherein said material comprises polytetrafluoroethylene.

43. An obturation device according to claim 34, further comprising a shielding body positionable on said blow rod between said aperture and said blocking body, said shielding body being sized smaller than said blocking body, said shielding body shielding said passageway within said blocking body from contamination.

44. An obturation device according to claim 43, wherein said shielding body is positionable adjacent to said blocking body.

45. An obturation device according to claim 43, wherein said shielding body comprises an elongated segment coaxially positionable on said blow rod.

46. An obturation device according to claim 45 wherein said shielding body further comprises a tapered end positionable facing said aperture.

47. An obturation device according to claim 43, wherein said shielding body has an outer surface comprising a material having a relatively low coefficient of friction.

48. An obturation device according to claim 47, wherein said material comprises polytetrafluoroethylene.

49. An obturation device according to claim 43, wherein said shielding body comprises a material having a relatively low coefficient of friction.

50. An obturation device according to claim 49, wherein said material comprises polytetrafluoroethylene.

51. An obturation device according to claim 34, wherein said obturation device is positioned on said blow rod proximate to said aperture.

52. An obturation device according to claim 51, further comprising a plurality of apertures in said blow rod, said apertures being positioned a equally spaced intervals circumferentially around said blow rod.
